(19) United States
(12) Patent Application Publication
(10) Pub. No.: US 2021/0054982 A1
(43) Pub. Date: Feb. 25, 2021

(54) DEPLOYABLE FIELD LIGHT HAVING VERTICAL SAFETY FEATURES

(71) Applicant: CONTROL DYNAMICS, INC., EVERETT, WA (US)

(72) Inventor: ERIC M. MORAN, CAMANO ISLAND, WA (US)

(21) Appl. No.: 16/549,027

(22) Filed: Aug. 23, 2019

(51) Int. Cl. F21S 8/08; F21S 9/02; F21V 21/22; F21V 23/04

(52) U.S. Cl. CPC F21S 8/086; F21S 9/02; F21Y 2115/10; F21V 23/0464; F21V 21/22

(57) ABSTRACT

Systems and methods disclosed herein are directed to a deployable field lighting apparatus that meets the requirements of a class 1, division 1 hazardous environment. All aspects of the electrical and mechanical components of the deployable field light are spark-resistant and impact resistant such that the raising, lowering and powering of the deployable field light may be accomplished in hazardous environments. Further, the deployable field light includes additional safety features that are suited to ensure that raised lighting components are prevented from crashing down during deployment or retrieval operations. The filed light prevents accidental falls and maintenance failures because all potential energy is controlled by vertical shaft screws with fixed and engaged screw nuts that prevent rapid vertical/linear motion in any direction. The deployable field light utilizes worm-gear mechanisms along with idler gear translational properties to exert safe control of vertical motion during any deployment operation.

### BACKGROUND

Field lighting is often required at worksites or other publicly accessible open spaces such as stadium and festival parking lots that are not often used to necessitate a more permanent lighting solution. Thus, portable field lights may be deployed as needed for the purpose of providing lighting in a space that requires illumination. Solutions of the past have included field lights having a gasoline-powered generator for providing the electric power for the lights. Such gasoline-powered generators are quite noisy and utilize gas rather inefficiently. Thus, gasoline-powered field lights are less desirable and even cost-prohibitive in some locations.

Further, some locations in need of lighting may be designated as a hazardous environment due the presence of explosive materials. Electrical equipment can cause explosions in certain hazardous environments and is highly regulated. Equipment used in areas where explosive concentrations of dusts or vapors may exist must be equipped with special wiring and other electrical components for safety purposes. Hazardous environments (classified as class division 1 as defined by the National Fire Protection Association (NFPA) Publication 70, National Electric Code® (NEC) in Articles 500 to 506.) locations such as these might exist in aircraft hangars, gasoline stations, paint-finishing locations or grain bins. Thus, a field lighting apparatus that complies with the safety requirements for class 1 division 1 locations is desirable.

### BRIEF DESCRIPTION OF THE DRAWINGS

Like reference numerals are used to designate like parts throughout the several view of the drawings, wherein:

FIG. 1 is a perspective view of a class 1 division 1 location that includes deployed field lighting according to an embodiment of the subject matter disclosed herein;

FIG. 2 is a perspective view of a deployable field lighting apparatus that complies with the requirements of class 1 division 1 locations in a deployed state according to an embodiment of the subject matter disclosed herein;

FIG. 3 is a perspective view of a deployable field lighting apparatus that complies with the requirements of class 1 division 1 locations in a stored state according to an embodiment of the subject matter disclosed herein;

FIG. 4 is a perspective view a telescoping mast of the deployable field light of FIGS. 2-3 according to an embodiment of the subject matter disclosed herein;

FIG. 5 is a perspective view of a motion-selection actuation transmission of the deployable field light of FIGS. 2-3 according to an embodiment of the subject matter disclosed herein;

FIG. 6 is a perspective view of an internal mast mechanism showing two different inter-segment worm gear linkages 470a/b of the deployable field light 120 of FIGS. 2-3 according to an embodiment of the subject matter disclosed herein; and

FIG. 7 is a block diagram of the systems embodied in the deployable field light of FIGS. 2-3 according to an embodiment of the subject matter disclosed herein.

### DETAILED DESCRIPTION

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments will be described more fully hereinafter with reference to the accompanying drawings, which form a part hereof, and which show, by way of illustration, exemplary embodiments by which the systems and methods described herein may be practiced. This systems and methods may, however, be embodied in many different forms and should not be construed as limited to the embodiments set forth herein; rather, these embodiments are provided so that this disclosure will satisfy the statutory requirements and convey the scope of the subject matter to those skilled in the art.

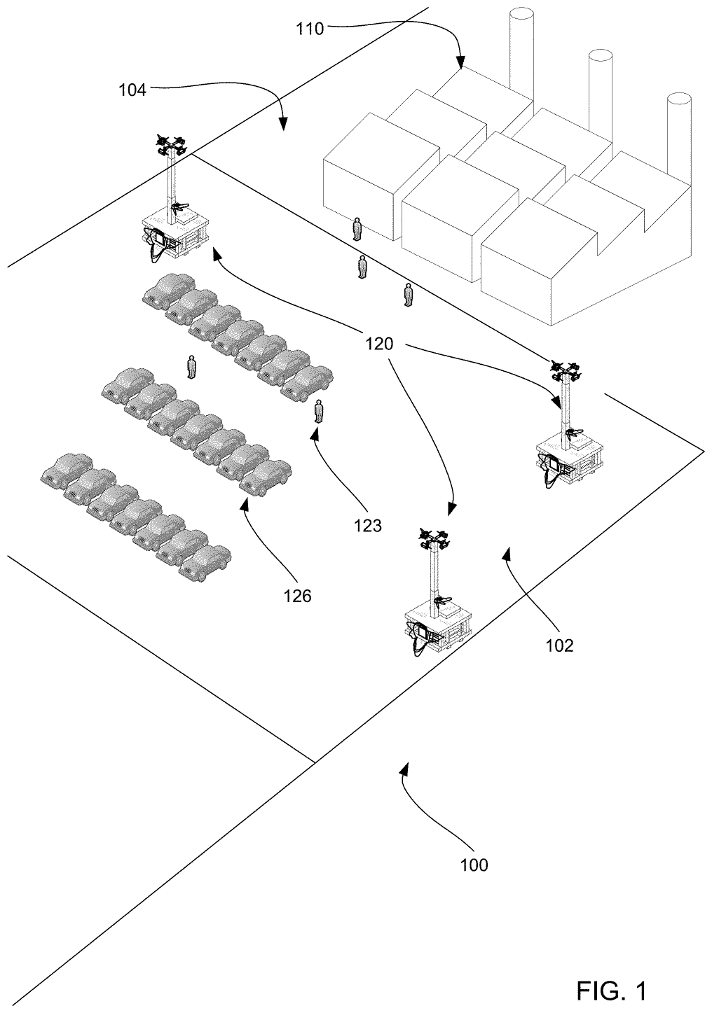

By way of an overview, systems and methods disclosed herein are directed to a deployable field lighting apparatus that meets the requirements of a class 1, division 1 hazardous environment. In various embodiments, all aspects of the electrical and mechanical components are spark-resistant and impact resistant such that the raising, lowering and powering of a deployable field light may be accomplished in hazardous environments that must comply with class 1, division 1 criteria. Further, the deployable field light includes additional safety features that are suited to ensure that raised lighting component are prevented from crashing down during deployment or retrieval operations. That is, a conventional lighting apparatus may rely on pulleys to raise and lower field lights above but become dangerous if the pulley system slips or fails after a lengthy deployment. Current embodiments of the field light of the subject matter discussed herein prevent accidental falls and maintenance failures because all potential energy is controlled by vertical shaft screws with fixed and engaged screw nuts that prevent rapid vertical/linear motion in any direction. As is discussed below with respect to FIGS. 1-7, a deployable field light according to embodiment herein utilize worm-gear mechanisms along with idler gear translational properties to exert safe control of vertical motion during any deployment operation. These and other aspect are better understood with respect to the descriptions below in conjunction with FIGS. 1-7.

FIG. 1 is a perspective view of a class 1 division 1 environment 100 that includes deployed field lighting 120 according to an embodiment of the subject matter disclosed herein. As shown in FIG. 1, the environment 100 may be situated at, near, adjacent to, within, or around an industrial or manufacturing stetting 104 having one or more industrial complexes 110 where some form of a hazardous material or substance is present necessitating classification of the environment as class 1 division 1. Thus, in one embodiment, the field lighting may be deployed in a parking lot 102 next the industrial complexes 110 such that humans may be walking about and/or cars may be parked. Of course, in a class 1, division 1 environment, the cars in the parking lot 102 would also need to be rated as class 1 division 1 vehicles, so the illustration in FIG. 1 may also be simply a parking lot 102 in need to deployable filed lighting 120 just the same without the class 1 division 1 designation. In either case, FIG. 1 is simply an illustration of one possible use of the deployable field lighting 120 as discussed further below. For the purposes of this disclosure, however, the remainder of the discussion will be toward descriptions of a deployable field lighting apparatus that is rated for class 1 division 1 environments.

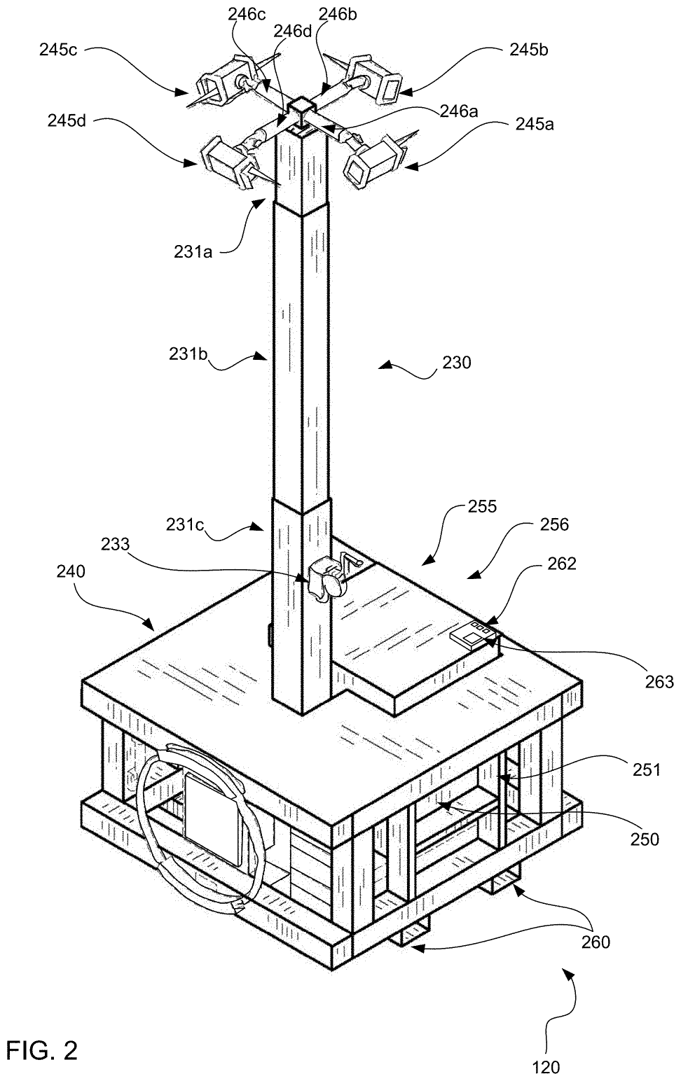

To further delve into the types of environments designated as class 1 division 1, some additional discussion may be useful. Class I locations are those in which flammable gases or vapors are or may be present in the air in quantities sufficient to produce explosive or ignitable mixtures. Class I locations are further subdivided into two Divisions and three Zones, though this discussion is only concerned with division 1. Division 1 may be defined as one of three different situations that could exist to classify an area as a Class I, Division 1. These situations comprise: 1) presence of ignitable concentrations of flammable gases or vapors that may exist under normal operating conditions, 2) ignitable concentrations of gases or vapors that may exist frequently because of repair or maintenance operations or because of leakage, and 3) possibility of breakdown or faulty operation of equipment or processes that may release ionitable concentrations of flammable gases or vapors, and may also cause simultaneous failure of electric equipment. Each of these situations will require all equipment designated for use within class 1 division 1 environments to include safety measures to prevent internal combustion or possibility of friction-actuated sparking so as to prevent the possible ignition of gases and/or vapors resulting in fire or explosion. The deployable lights 120 as described below with respect to FIGS. 2-7 meet the requirements of class 1 division 1 as generally understood in the industry.

FIG. 2 is a perspective view of a deployable field lighting apparatus 120 that complies with the requirements of class 1, division 1 locations in a deployed state according to an embodiment of the subject matter disclosed herein. The deployable field lighting apparatus 120 includes a base 240 (sometimes called a brick skid base 240) that features an aluminum structure (or other suitable metal) that is suited to be sufficiently light weight enough for maneuverability and portability while still provide enough structural support to maintain a telescoping mast 230 in an upright position as well as housing a rechargeable battery 250 secured behind a lockable access structure 251. Although described as “lightweight aluminum,” the base 240 is heavy enough (typically having a total weight approximately 2,250 pounds) to prevent accidental toppling of the telescoping mast 230 when deployed (e.g., when the telescoping mast is extended fully upward). The term lightweight designation refers to the ease of lifting the base 240 using a forklift as the base includes receptacles 260 for forklift forks to engage the base 240 for maneuvering and resetting. However, a skilled artisan understands that the base 240 remains heavy enough to maintain the position of the overall deployable lighting apparatus 120 in the face of heavy winds or from mischievous engagement from one or more humans.

The battery block 250 secured within the base 240 includes a rechargeable set of batteries forming and overall battery block 250 that may have an overall battery life of several weeks for the electric bad of the lights 245a-d. The battery block 250 circuit operates at 60 volts and may deliver power to the group of lights 245a-d having an overall power draw of 100-200 watts in total. The lights 245a-d may be LED lights that have a low power draw. Although shown as four lights 245a-d, the light bank may include any number of lights providing a large number of lumens ranging from 5,000-10,000 lumens. The rechargeable battery block 250 may include a lead coupling cable (not shown) for recharging that may be detachable or stored within the base 240 when not being used for recharging.

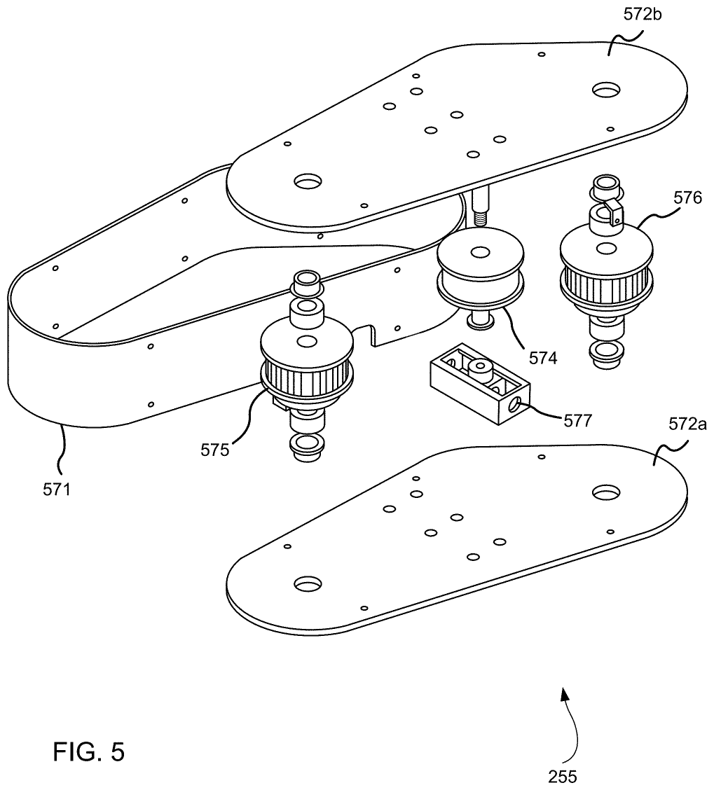

As briefly mentioned above, the deployable field lighting apparatus 120 includes a telescoping mast 230 that may be automatically or manually extends upward (e.g., deployed state) or retracted downward (e.g., storage state). One may manually crank the telescoping mast 230 upward or downward using manual crank apparatus 233 where rotational motion from cranking extends or retracts the telescoping mast 230 vertically. The telescoping mast 230 may also be automatically raised or lowered from rotational energy imparted via an on-board electric motor 256 (not shown but indicated as inside the base 240). The rotational motion imparted from the electric motor or from the manual crank apparatus may be translated into vertical motion of the telescoping mast through a motion-selection actuation transmission 255 (described in greater detail below with respect to FIG. 5 and not shown in FIG. 2 as it is also indicated as being inside the base 240).

The telescoping mast 230 may include two or more segments. In this embodiment, the telescoping mast 230 includes a first upper segment 231a, a second middle segment 231b and a third lower segment 231c. At the top of the telescoping mast 230, a lighting fixture may be affixed that includes the afore-mentioned lights 245a-245d. The light fixture may further comprise a plurality of extension members 246a-246d, each extension member 246a-246d including a first end coupled to the mast 230 and a second end disposed away from mast 230 and emanating in a normal direction (e.g., 90 degrees) with respect to the mast axis. Further, each extension member emanates in a direction of emanation equidistant from each adjacent extension member. Thus, with four extension members 246a-246d as shown in this figure, this means that each member 246a-246d emanates in a cardinal direction (e.g., north, south, east, and west) or, put another way, each extension member 246a-246d, in the case of four is exactly 90 degrees offset form any adjacent member 246a-246d. Further, each extension member 246a-246d includes an LED light disposed at the second end of the extension member 246a-246d.

In other embodiments not shown, the telescoping mast 230 may have between two and six segments. With the segments 231a-c being of a telescoping nested nature (e.g. segment 231a can nest inside segment 231b when retracted and segment 231b can nest inside segment 231c when retracted), the telescoping mast 230 can reach up to 20 or more feet upward when deployed but the retract down to a total storage state height of eight feet or less. A typical deployed height is 15 feet.

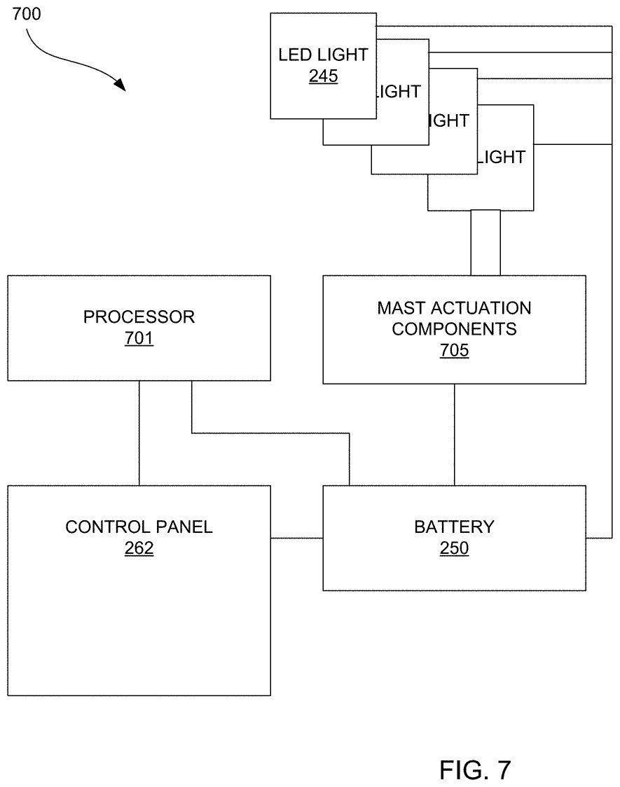

The deployable field light 120 includes automated controls 262 for extending and retracting the telescoping mast 230. Further, the control panel 262 may be used to program an on/off schedule for the lighting bank 245a-d. Further yet, the control panel may include a light sensor 263 for sensing ambient light such that the lighting bank 245a-d may be turned on if the light sensor determines that the ambient light falls below a threshold level. Aspects of the automated controls are discussed further below with respect to FIG. 7.

The deployable field light 120 is rated for class 1 divisional 1, hazardous environments. To meet the requirements of class 1, division 1, the entire lighting apparatus 120 must have no exposed electric contacts that may spark causing a possible igniting or exploding of flammable gases or liquids that may present in the environment. Further, no metal parts of the telescoping mast 230 or the telescoping mast actuation transmission 255 are subject to dry friction that may lead to sparking under contact or manipulation. Thus, the deployable field light 120 includes lubrication for all manipulatable components that prevents sparking in any manner of actuation or manipulation.

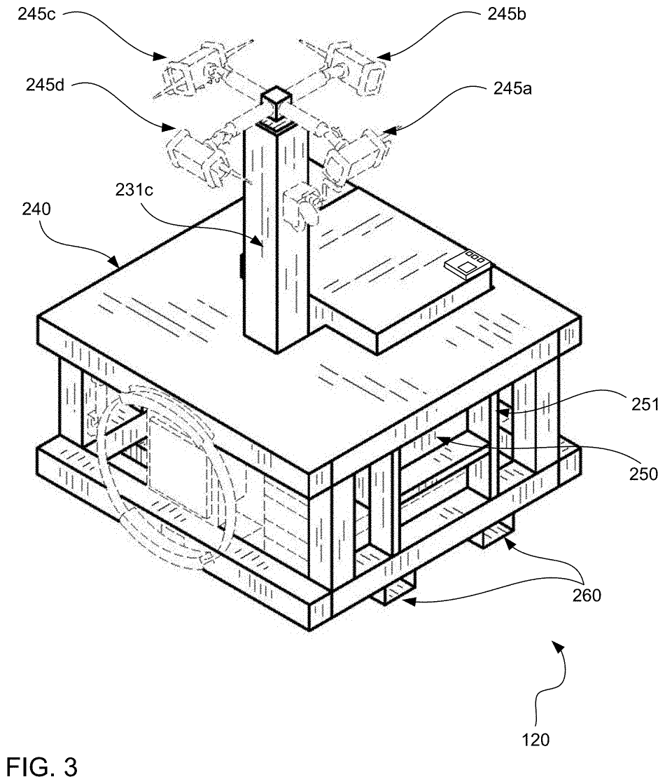

FIG. 3 is a perspective view of a deployable field lighting apparatus 120 of FIG. 2 that is shown in a stored state according to an embodiment of the subject matter disclosed herein. In this view, the telescoping mast 230 is shown in a retracted position and therefore, the segments (as shown in FIG. 2) are nested within each other. That is, segment 231a is nested within segment 231b which is, in turn, nested within segment 231c. Thus, segment 231c can be seen in FIG. 3. With a retracted telescoping mast, the overall height of the deployable field light may be 6-8 feet which is short enough for easier transport and storage.

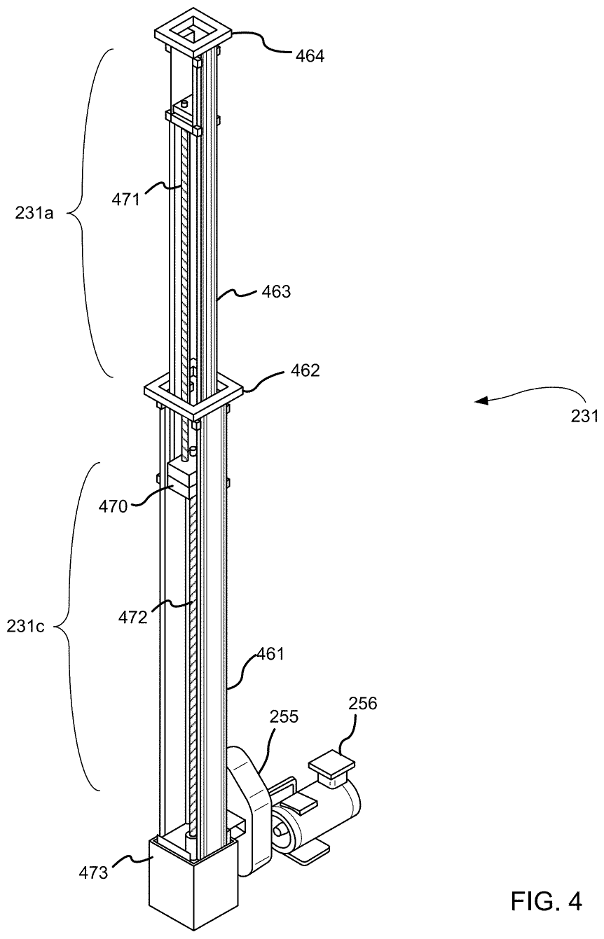

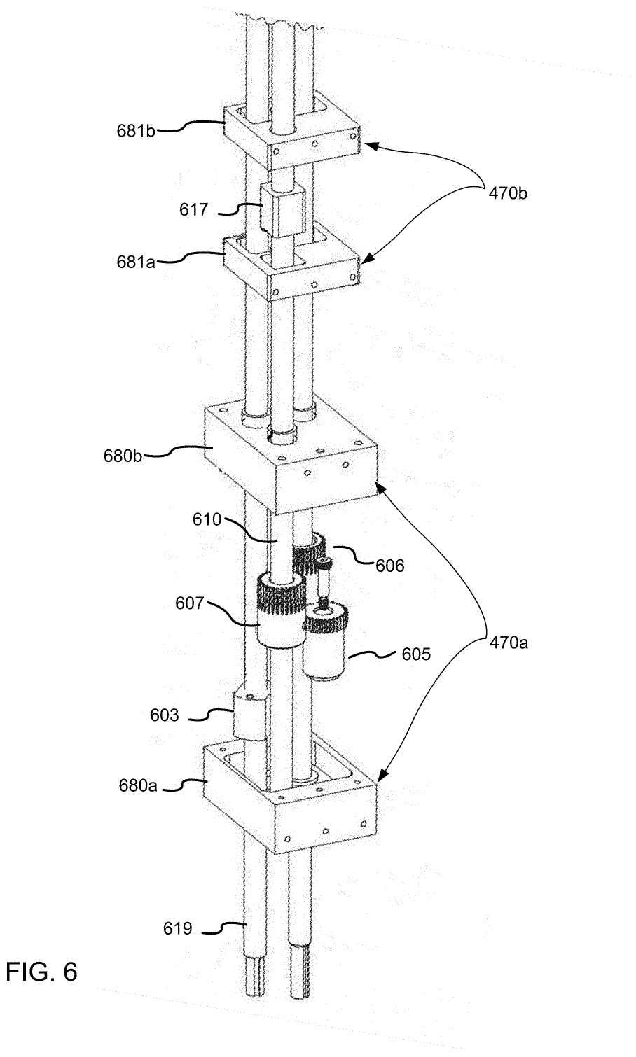

FIG. 4 is a perspective view a telescoping mast 230 and other components of the deployable field light 120 of FIGS. 2-3 according to an embodiment of the subject matter disclosed herein. In this figure, the deployable mast 230 is shown with some exterior portions removed so as to reveal the interior components of each segment in the segmented telescoping mast 230. Further, for ease of illustration, this embodiment is shown with two segments, a first segment 231c disposed closest to the base unit (not shown) and a second segment 231c configured to nest within the first segment 231c when retracted. As skilled artisan understands that the principles and components described with respect to the two segments 231c and 231a shown in FIG. 4 may generally describe embodiments having more than two segments. To this end, a portion of the telescoping mast components are shown further below with respect to FIG. 6 with a mechanism suited to three segments. For now, the focus remains on the embodiment of FIG. 4.

In FIG. 4, additional components are shown in addition to the segmented mast 230. These components include a mast support structure 473 next to the afore-mentioned on-board electric motor 256 and telescoping mast actuation transmission 255. The mast support structure 473 may be attached and/or secured to a top side of the base unit (240 of FIGS. 2-3) on the facing that is situated on the top-side of the base unit. The mast support structure 473 provides an attachment position for supporting the segmented mast 230 is a vertical direction (e.g., a direction normal to the facing of the top-side of the base unit. Assuming the base unit is setting on the ground, this direction is also normal to the surface of the ground. Further, the first segment 231c is the portion of the segmented mast 230 that is affixed to the mast support structure 473 such that this segment does not move form its fixed position with respect to the mast support structure 473 and the base unit 240. As discussed above, the mast support structure 473, the on-board electric motor 256, and the telescoping mast actuation transmission 255 may all be located within the base unit (not shown).

Each segment 231c and 231a of the segmented mast 230 comprises a hollow housing that features an elongated cavity having an axis that is aligned with an axis normal to the face in which the mast support structure is disposed. That is, segment 231c has a housing 461 that includes an enclosed elongated cavity inside the segment 231c where additional components may be housed. Likewise, segment 231a has a housing 463 that includes an enclosed elongated cavity inside the segment 231a where additional components may be housed. Further, the first segment may include a first end cap 462 having an orifice that is at least as large as (and shaped similar to) the cross-sectional area of the next subsequent segment 231a. The first end cap helps facilitate the nesting of the next subsequent segment 231a when the segmented mast 230 is retracted for a storage and/or transport mode of operation. The second segment 231a is also shown having an end cap 464 that may be attached to a light fixture (245-246 of FIG. 2). In other embodiments (not shown), this end cap 464 may facilitate another subsequent segment (also not shown).

In this embodiment and any embodiment, the electric motor 256 may be used to impart rotational motion through the mechanically coupled telescoping mast actuation transmission 255. Thus, as the motor 256 is rotated in a first direction, one or more segments of the telescoping mast 230 may be raised away from the base unit 240. Similarly, as the motor 255 is rotated in a second, opposite direction, the same one or more segments of the telescoping mast 230 may be lowered toward the base unit 240 in a nested manner. The mechanism by which the raising and lowering of the one or more segments is achieved is through a system of mechanically coupled vertical worm gear shafts 472 and 471 disposed inside the respective elongated cavities of the segments 231a and 231c. Each worm gear shaft 472 and 471 is coupled to an inter-segment worm gear linkage 470. The specific nature of the coupling (whether it be affixed or operable) is described below with respect to FIG. 6.

The segmented mast 230, when utilizing the respective vertical worm-gear shafts 471 and 472, prevents slippage and falls of the extended (e.g., raised) segments. Preventing slips and falls of the raised segments is an improvement to safety of eth overall deployable light apparatus as the segments that are raised are physically prevents from slipping or crashing back down as the respective worm gear shafts 471 and 472 remain engaged with the mast actuation transmission 255 and/or the inter-segment worm-gear linkage 470. Further, the segmented mast 230 may utilize concentrically aligned and nested segments to provide a more compact storage state where all segments, when retracted, are nested inside each other. That is, the first segment 231c has a first elongated cavity with a first cross-sectional area. The second shown segment 231a in FIG. 4 (or any next subsequent segment on other embodiments) has a cross-sectional area that is smaller than the cross-sectional area of the previous segment (e.g., the first segment 231c) such that the second segment 231a may be nested concentrically when retracted toward the base unit 240.

Further yet, as mentioned above, all components associated with the overall deployable lighting apparatus 120 comply with the requirements of class 1, division 1 hazardous environment safety provisions. This is to prevent accidental explosions and/or fires due to the flammable nature of the class 1 division 1 hazardous environment. In practice, this means that all electrical contact points comply with non-sparking standards and that all mechanical contacts points under load are lubricated to arrest any possible sparking. Thus, within the elongated cavities of the segments 231a-231c, the vertical worm gear shafts 471 and 472 are lubricated and in some embodiments, the entire elongated cavity is filled with a lubricant liquid. Further, the inter-segment gear linkage 470 and the mast actuation transmission 255 are also appropriately lubricated and contact non-sparking electrical contacts.

FIG. 5 is a perspective view of a motion-selection actuation transmission 255 of the deployable field light 120 of FIGS. 2-3 according to an embodiment of the subject matter disclosed herein. The motion-selection actuation transmission 255 is configured to translate the rotational motion from either an attached actuation motor 256 (not shown here) or a manual hand crank 233 (also not shown here) into a rotational motion of respective mast screw (described below). Thus, as the motor turns, the concentrically coupled motor interface 575 also turns in concert. Similarly, as the hand crank turns, the concentrically coupled motor interface 576 also turns in concert. The motion-selection actuation transmission 255 is configured to thrust an interface gear 574 to engage the motor interface 575 when the overall system is operating is a electric motor mode of operation. Similarly, the motion-selection actuation transmission 255 is configured to thrust an interface gear 574 to engage the hand crank interface 576 when the overall system is operating is a manual of operation. The mode of operation may be engaged through an actuation selection mechanism that may manually set of automatically set though the control panel of FIG. 2. Lastly, the overall motion-selection actuation transmission 255 may be housed via portions of a housing that includes a transmission housing 571 configured to engage with a first cover plate 572a and a second cover plate 572b.

FIG. 6 is a perspective view of an internal mast mechanism showing two different inter-segment worm gear linkages 470a/b of the deployable field light 120 of FIGS. 2-3 according to an embodiment of the subject matter disclosed herein. The inter-segment worm gear linkage 470a includes a top housing member 680b and bottom housing member 680a that encompasses additional components within the top and bottom housing portions 680a/b. The inter-segment worm gear linkage 470b includes a top housing member 681b and bottom housing member 681a that encompasses additional components within the top and bottom housing portions 681a/b. Additional components include a first vertical worm gear shaft interface gear 607 and a second vertical worm gear shaft interface gear 606 as well as an engagement clutch 605. Together, the first vertical worm gear shaft interface gear 607 the second vertical worm gear shaft interface gear 606 and the engagement clutch 605 facilitate the raising and lowering of the segmented mast 230 in a manner described below.

In this embodiment, vertical shaft screw 619 may rotate in a first direction based on rotational motion imparted to it through a right-angle gear box in base of tower (not shown). An input shaft of the right-angle gear box may be coupled to a shaft of the electric motor (256 of FIG. 4) or the manual hand crank (233 of FIG. 2). The rotation of the screw vertical shaft screw 619 causes a first motion-imparting nut 603 to move in linear direction dependent on the direction of rotation of the vertical shaft screw 619. For example, rotating in a first direction (e.g., counter-clockwise), the linear motion of the nut 603 may be upwards (e.g., away from the overall base 230). Likewise, rotating in a second direction (e.g., clockwise), the linear motion of the nut 603 may be downwards (e.g., toward the overall base 230). The motion of the nut 603 causes first inter-segment worm gear linkage 470a to move linearly coincident with the nut 603 as the nut 603 may be affixed between the top and bottom housing members 680a/b. Simultaneously, the entire lower tower segment moves linearly as well as the lower tower section is also bolted to the inter-segment worm gear linkage 470a. That is, the shaft 610 is bolted to the bottom housing portion 680a of the first inter-segment worm gear linkage 470a.

As the first inter-segment worm gear linkage 470a moves linearly, the linear motion causes gear nut 606 that is affixed coincident with the lower tower section shaft 610 to be pushed linear against the idler screw 620 (the idler screw 620 is affixed to the base 230 so as to be stationary so linear motion of its respective gear nut 607 is caused rotation by the first gear nut 606 now set against the idler screw 620 via mechanical linkage using an idler gear 605. That is, gear nut 606 rotates and engages the idler gear 605 and transfers rotational force to gear nut 607. Gear nut 607 is mechanically pinned to vertical shaft screw 621 which causes vertical shaft screw 621 to rotate when gear nut 607 is rotated.

As the vertical shaft screw 621 now rotates, nut 617 begins to move linearly (e.g., upwards with a first rotations direction and downwards with a second rotation direction). Similar to above, nut 617 is affixed between top and bottom housings 681a/b of the second inter-segment worm gear linkage 470b and thereby causes the second inter-segment worm gear linkage 470b to move linearly as well. Thus, an upper tower section affixed to the second inter-segment worm gear linkage 470b also move linearly.

The above-described mechanisms may be repeated in further embodiments having more than two sections, but for the sake of brevity, only two segments are discussed here. Thus, when in an initial, undeployed state, an operator may engage the electric motor or manual hand crank to raise each segment simultaneously. That is, as eth first segment begin to rise away from the base, the second segment also begins to rise away from the first segment. Thus, each segment is moving simultaneously away from the next previous section (e.g., the first segment away from the base and the second segment away form the first segment). Thus, the overall motion of the second segment away from the base as compared the first segment motion away from the base will be larger. In some embodiment the rate of movement of the second segment is twice that of the first segment, but other embodiments are possible depending on gear ratio between the gear nuts 606 and 607. Retracting the field light from a deployed state operates in a similar manner, but in reverse as that which was described above with respect to upwards motion.

FIG. 7 is a block diagram 700 of the systems embodied in the deployable field light 120 of FIGS. 2-3 according to an embodiment of the subject matter disclosed herein. The block diagram 700 shows several components that work in concert to facilitate deployment (e.g., extension) or storage (e.g., retraction) of the lighting apparatus. The overall system includes a control circuit 262 that may be disposed in the base unit 240 (shown in FIG. 2) that is coupled to a local processor 701 for facilitating automated control features of the overall system. In particular, the processor 701 may be configured to control an on/off schedule for the lights 245 of the system. Thus, the processor 701 may be configured to turn on the light fixture 245 at a first specified time (e.g., 6 PM local time) and configured to turn off the light fixture 245 at a second specified time (e.g., 2 AM local time). In another embodiment, the processor 701 may be configured to control an on/off schedule for the lights 245 of the system based on ambient light level. Thus, the processor 701 may be configured to turn on the light fixture 245 when a sensed ambient light falls below a threshold (as sensed by sensor 263 of FIG. 2) and configured to turn off the light fixture when the sensed ambient light rises above the threshold. Further yet, the processor 701 may be configured to control and facilitate the extension and retraction of the mast actuation components 705 that may collectively comprise the telescoping mast actuation transmission 255, the on-board electric motor 256, the inter-segment worm gear linkage 470, and other related components as described above.

It is to be understood that many changes in the particular structure, materials, and features described herein may be made without departing from the spirit and scope of the subject matter. Therefore, it is the Applicant's intention that its patent rights not be limited by the particular embodiments illustrated and described herein, but rather by the following claims interpreted according to accepted doctrines of claim interpretation, including the Doctrine of Equivalents and Reversal of Parts.

What is claimed is:

1. A lighting apparatus, comprising:
a base unit comprising a frame enclosing a cavity suitable for supporting a battery bank and having a mast support structure disposed on a face of the frame;
a segmented mast coupled to the mast support structure, each segment of the segmented mast including an elongated cavity having an axis that is aligned with an axis normal to the face in which the mast support structure is disposed; and
a light fixture disposed on one end of one segment, the light fixture configured to be powered by a battery disposed in the cavity.

2. The lighting apparatus of claim 1, wherein the light fixture further comprises a plurality of extension members, each extension member including a first end coupled to the mast and a second end disposed away from mast and emanating in a normal direction with respect to the mast axis, each extension member having a direction of emanation equidistant from each adjacent extension member and each extension member having an LED light disposed at the second end of the extension member.

3. The lighting apparatus of claim 1, wherein segmented mast comprises a plurality of two and five segments.

4. The lighting apparatus of claim 1, wherein the segmented mast further comprises:
a respective vertical worm gear shaft disposed within each elongated cavity of each segment; and
an inter-segment worm gear linkage disposed between at least a first segment and a second segment such that the inter-segment worm gear is affixed to the first segment and operably coupled the second segment.

5. The lighting apparatus of claim 4, further comprising a motor disposed in the frame and configured to extend the segmented mast such that one or more segments are maneuvered vertically away from the base unit by rotating the respective worm gear in a first rotational direction and configured to retract the segmented mast such that one or more segments are maneuvered vertically toward the base unit by rotating the respective worm gear in a second rotation direction opposite the first rotation direction.

6. The lighting apparatus of claim 4, further comprising a manual crank disposed on the segmented mast and configured to extend the segmented mast such that one or more segments are maneuvered vertically away from the base unit by rotating the respective worm gear in a first rotational direction and configured to retract the segmented mast such that one or more segments are maneuvered vertically toward the base unit by rotating the respective worm gear in a second rotation direction opposite the first rotation direction.

7. The lighting apparatus of claim 1, wherein the segmented mast further comprises:
a first segment having a first elongated cavity with a first cross-sectional area; and
one or more subsequent segments, each subsequent segment having a subsequent cross-sectional area that is smaller than the cross-sectional area of the previous segment such that al segments may be nested concentrically when retracted toward the base unit.

8. The lighting apparatus of claim 1, further comprising:
one or more rechargeable batteries disposed within the cavity of the frame; and
a recharging lead coupled to the one or more rechargeable batteries configured to engage a remote recharging device.

9. The lighting apparatus of claim 1, further comprising a control circuit disposed in the base unit and configured to turn on the light fixture at a first specified time and configured to turn off the light fixture at a second specified time.

10. The lighting apparatus of claim 1, further comprising a control circuit disposed in the base unit and configured to turn on the light fixture when a sensed ambient light falls below a threshold and configured to turn off the light fixture when the sensed ambient light rises above the threshold.

11. The lighting apparatus of claim 1, wherein all components within the lighting apparatus are rated to comply with requirement for a class one division one hazardous environment.

12. The lighting apparatus of claim 1, wherein all components within the lighting apparatus comprises non-sparking contacts having lubrication to reduce friction.

13. A portable device support, comprising:
a base having a battery and a control circuit;
a mast having a plurality of segments wherein the control circuit is configured to cause a worm gear apparatus disposed inside each of the plurality of segments to extend at least one of the plurality of segments away from the base; and
an electric device disposed on top of the segment that is extended away from the base, the electric device communicatively coupled to the control circuit.

14. The portable device of claim 13, wherein the electric device comprises a lighting apparatus having a plurality of LED lights.

15. The portable device of claim 13, wherein the electric device comprises an audio speaker system having a plurality of audio monitors.

16. The portable device of claim 13, wherein the electric device comprises a video display system having a one or more video monitors.

17. The portable device of claim 13, wherein the control circuit comprises a processor configured to execute computer-readable instructions stored in a memory coupled to the processor.
